(19) United States
(12) Patent Application Publication
(10) Pub. No.: US 2009/0238483 A1
(43) Pub. Date: Sep. 24, 2009

(54) Image processing apparatus, image processing method, and computer program product

(75) Inventor: Tamon Sadasue, Tokyo (JP)

Correspondence Address: HARNESS, DICKEY & PIERCE, P.L.C., P.O. BOX 8910, RESTON, VA, 20195, US

(73) Assignee: Ricoh Company, Ltd.,

(21) Appl. No.: 12/379,857

(22) Filed: Mar. 3, 2009

(30) Foreign Application Priority Data
Mar. 19, 2008 (JP) 2008-071812

(51) Int. Cl. G06K 9/36; G06K 9/40

(52) U.S. Cl. 382/248; 382/274

(57) ABSTRACT

A determining unit determines whether a background pixel value of image data matches a predetermined comparison value. A replacing unit replaces, when the determining unit determines that the background pixel value does not match the comparison value, a pixel value of a pixel of the image data with a replacing value that is obtained by subtracting the pixel value from a predetermined maximum pixel value. An encoding unit generates encoded data by encoding the image data in which the pixel value is replaced with the replacing value by using a predetermined encoding system.

### CROSS-REFERENCE TO RELATED APPLICATIONS

The present application claims priority to and incorporates by reference the entire contents of Japanese priority document 2008-071812 filed in Japan on Mar. 19, 2008.

### BACKGROUND OF THE INVENTION

1. Field of the Invention

The present invention relates to a technology for encoding image data at a plurality of resolutions.

2. Description of the Related Art

Due to increase in resolution of a digital camera or a scanner, demands for handling high-resolution still images have been increasing. Along with the increase in the demands, functions required for an image compression/decompression technique that facilitates handling of the high-resolution still images are diversified. Currently, the joint photographic experts group (JPEG) is the most widely used as an image compression/decompression algorithm for high-resolution still images. In recent years, usage of an image compression/decompression algorithm that uses the discrete wavelet transform (DWT) for frequency transformation also increases. A JPEG 2000 encoding system is a typical example of an algorithm that uses the DWT.

A resolution scalability is one of the significant features of the JPEG 2000. The resolution scalability is useful especially when a target image is to be viewed by converting the image into an image of a desired size. The image size of a high-resolution still image that is to be displayed is determined based on a dot pitch and a dot size when capturing signals by the digital camera or reading signals by the scanner. In other words, once data corresponding to a specific still image format is created, the image size is kept constant. However, a required view size (resolution) is not always the same at the time of viewing the image. For example, a size (resolution) of a liquid crystal display (LCD) monitor of a digital camera significantly differs from a display size (resolution) when the saved data is to be displayed on a personal computer.

When image data that is encoded by a system such as the JPEG that does not have a function of the resolution scalability is to be displayed in a desired size, generally, it is necessary to execute a zooming process after a decoding process is executed for the entire encoded data and the data is loaded into pixel data (bitmap). However, when the image data that is encoded by using the JPEG 2000 encoding system is to be displayed in a reduced size, the pixel data (bitmap) can be generated by executing the decoding process only with respect to a portion of the image data (hereinafter, “reduction decoding”). In other words, a memory required for the decoding process can be reduced and a processing time period required for the decoding process can also be shortened.

When a high-resolution still image is a black and white image or when a character area is saved as a monochromatic data separately from a background area, an original image is often treated as an input of a binary image and is encoded to binary data. Fewer bits are required for expressing one pixel in the binary data compared to multivalued data, thus saving storage capacity.

However, when the binary image is encoded by the JPEG 2000 and the binary image data is converted into the pixel data by the reduction decoding, a thin line may break up. The breaking up of the thin line occurs due to the wavelet transformation of the JPEG 2000 encoding process. For example, in the wavelet transformation during a lossless encoding of the binary image, at the time of calculating a wavelet coefficient, a rounding process is executed for converting the wavelet coefficient into an integer and subsequently, pixels are downsampled at every two pixels. The breaking up of the thin line does not occur in an area in which the same pixel value continues. However, if the thin line exists in a white area, because a width of the area having the same pixel value is narrow, black pixels do not remain in the process and the thin line becomes white.

The breaking up of the thin line also occurs when the data, encoded by using the encoding system (JPEG, graphics interchange format (GIF), etc.) that does not have a function of the resolution scalability, is decoded and subsequently displayed in a reduced size at nearest neighbor. For reducing the breaking up of the thin line, many display applications execute a smoothing process that uses various algorithms such as a linear interpolation (bilinear) and a tertiary interpolation (bicubic interpolation), thus correcting the breaking up of the thin line.

A technology is proposed in Japanese Patent Application Laid-open No. 2003-189093 in which a character edge and an outline edge of a photographic object in a photograph area are appropriately discriminated and the appropriate smoothing process is executed in respective areas.

Although a conventional smoothing process can be executed in the JPEG 2000 encoding process, because all the original data is not read during the reduction decoding of the JPEG 2000, the smoothing process requires reading of data at a higher resolution than the resolution required for display. Due to this, merits of the reduction decoding are reduced.

In a method, which is presumed as another countermeasure, a binary original image is input as a multivalued data, i.e., for example, 1-bit pixel data of 0 or 1 is converted into 8-bit pixel data of 0 or 255 to be encoded as 8-bit data. Due to this, intermediate values that are not expressed by 1-bit in a coefficient space can be obtained. Thus, although the pixel data that is displayed after the reduction decoding becomes a multivalued gray image, an image can be obtained in which breaking up of the thin line is corrected by the intermediate values.

However, in the method mentioned earlier, the original data that is the binary image is extended to the multivalued data, thus increasing a code size and significantly increasing cost of the decoding process. Because multivalued data is output even with the binary data input, constraints on an input device and an output device do not match. For example, the multivalued data cannot be used in a portable device that outputs binary data.

### SUMMARY OF THE INVENTION

It is an object of the present invention to at least partially solve the problems in the conventional technology.

According to an aspect of the present invention, there is provided an image processing apparatus including a determining unit that determines whether a background pixel value of image data matches a predetermined comparison value; a replacing unit that replaces, when the determining unit determines that the background pixel value does not match the comparison value, a pixel value of a pixel of the image data with a replacing value that is obtained by subtracting the pixel value from a predetermined maximum pixel value; and an encoding unit that generates encoded data by encoding the image data in which the pixel value is replaced with the replacing value by using a predetermined encoding system. The encoding system encodes the image data using transform coefficients obtained by transforming the image data into a plurality of frequency components and that includes a process of rounding the transform coefficients.

Furthermore, according to another aspect of the present invention, there is provided an image processing method including determining whether a background pixel value of image data matches a predetermined comparison value; replacing, when it is determined at the determining that the background pixel value does not match the comparison value, a pixel value of a pixel of the image data with a replacing value that is obtained by subtracting the pixel value from a predetermined maximum pixel value; and generating encoded data by encoding the image data in which the pixel value is replaced with the replacing value by using a predetermined encoding system. The encoding system encodes the image data using transform coefficients obtained by transforming the image data into a plurality of frequency components and that includes a process of rounding the transform coefficients.

Moreover, according to still another aspect of the present invention, there is provided a computer program product including a computer-usable medium having computer-readable program codes embodied in the medium. The program codes when executed cause a computer to execute determining whether a background pixel value of image data matches a predetermined comparison value; replacing, when it is determined at the determining that the background pixel value does not match the comparison value, a pixel value of a pixel of the image data with a replacing value that is obtained by subtracting the pixel value from a predetermined maximum pixel value; and generating encoded data by encoding the image data in which the pixel value is replaced with the replacing value by using a predetermined encoding system. The encoding system encodes the image data using transform coefficients obtained by transforming the image data into a plurality of frequency components and that includes a process of rounding the transform coefficients.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image processing apparatus according to an embodiment of the present invention;

FIG. 2 is a flowchart for explaining an encoding process according to the embodiment;

FIG. 3 is a schematic diagram illustrating an example of a JP2 file format;

FIG. 4 is a schematic diagram for explaining a detailed structure of a pallet box shown in FIG. 3;

FIG. 5 is a schematic diagram illustrating an example of image data having a pixel value of a thin line as one;

FIG. 6 is a schematic diagram illustrating an example of the image data having a pixel value of the thin line as zero;

FIG. 7 is a schematic diagram illustrating an example of an original image having a background pixel value as one;

FIG. 8 is a schematic diagram illustrating an example of a result that is obtained when the background pixel value is one; and

FIG. 9 is a schematic diagram illustrating an example of a result that is obtained when the background pixel value is inverted to zero.

### DETAILED DESCRIPTION OF THE PREFERRED EMBODIMENTS

Exemplary embodiments according to the present invention are explained in detail below with reference to the accompanying drawings.

Similarly to the joint photographic experts group (JPEG) 2000 system including discrete wavelet transform (DWT) that uses a 5/3 filter, when encoding image data by using a transform encoding system that includes a process for rounding a transform coefficient to an integer value, an image processing apparatus according to an embodiment of the present invention executes an encoding process after pixel values of original image data are inverted according to background pixel value.

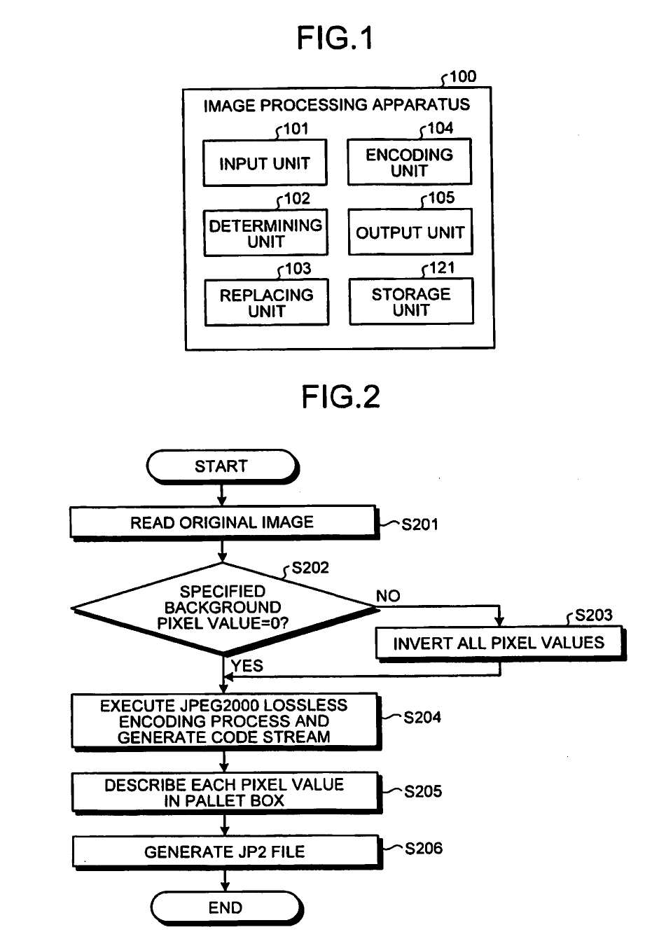

FIG. 1 is a block diagram of an image processing apparatus 100 according to the embodiment. As shown in FIG. 1, the image processing apparatus 100 includes a storage unit 121, an input unit 101, a determining unit 102, a replacing unit 103, an encoding unit 104, and an output unit 105.

The storage unit 121 stores therein various computer programs or various data handled in a key generation process. The storage unit 121 can include all typically used storage media such as a hard disk drive (HDD), an optical disk, a memory card, and a random access memory (RAM).

The input unit 101 inputs the original image data that is an encoding target image data. The input unit 101 also inputs a background pixel value that is specified by a user and indicates a pixel value of a background of the original image data.

The determining unit 102 determines whether the background pixel value of the original image data matches zero that is a predetermined comparison value.

If the background pixel value is not zero, the replacing unit 103 replaces the pixel values included in the original image data by the inverted pixel values, thereby inverting the original image data. Inverting of the pixel values indicates replacing each pixel value by a value obtained by subtracting the pixel value from a predetermined maximum pixel value. For example, in the binary image, the image data is inverted to zero that is obtained by subtracting a pixel value 1 from a maximum pixel value 1. The image data is also inverted to one that is obtained by subtracting a pixel value 0 from the maximum pixel value 1.

Using a predetermined transform encoding system that includes a process for rounding the transform coefficient to the integer value, the encoding unit 104 generates an encoded data that includes the encoded input original image data or the original image data in which the pixel values are inverted. In the present embodiment, the encoding unit 104 encodes the original image data by using the transform encoding system that conforms to JPEG 2000. Apart from JPEG 2000, any encoding system that includes the process for rounding the transform coefficient to the integer value, for example, the encoding system that uses Hadamard transform can be used as the transform encoding system.

The output unit 105 outputs the encoded data generated by the encoding unit 104.

An encoding process performed by the image processing apparatus 100 according to the present embodiment is explained below. FIG. 2 is a flowchart for explaining the encoding process according to the present embodiment.

First, the input unit 101 inputs binary original data (Step S201), thus starting the lossless encoding that uses the 5/3 filter. When the lossless encoding is started, the input unit 101 receives specification of the pixel value of the background image in option settings.

Next, the determining unit 102 determines whether the specified background pixel value is zero (Step S202). If the background pixel value is not zero, in other words, the background pixel value is specified as one (No at Step S202), the replacing unit 103 generates an image in which all the pixel values in the original image data are inverted from zero to one or from one to zero and the original image data is replaced by the generated image data (Step S203).

Upon inverting the pixel values or upon determining at Step S202 that zero is specified as the background pixel value (Yes at Step S202), the encoding unit 104 performs the lossless encoding that uses the 5/3 filter specified in the JPEG 2000 standards (Step S204). The encoding unit 104 also executes at Step S204 a process until a Japan picture format (JPC) that is a code stream is generated.

Subsequently, the encoding unit 104 generates at Steps S205 and S206, a JP2 file including the generated code stream. A JP2 file format includes a plurality of code streams indicating images. Additionally, the JP2 file format can also provide information such as metadata or features of an image, intellectual property rights, vendors, and color profiles.

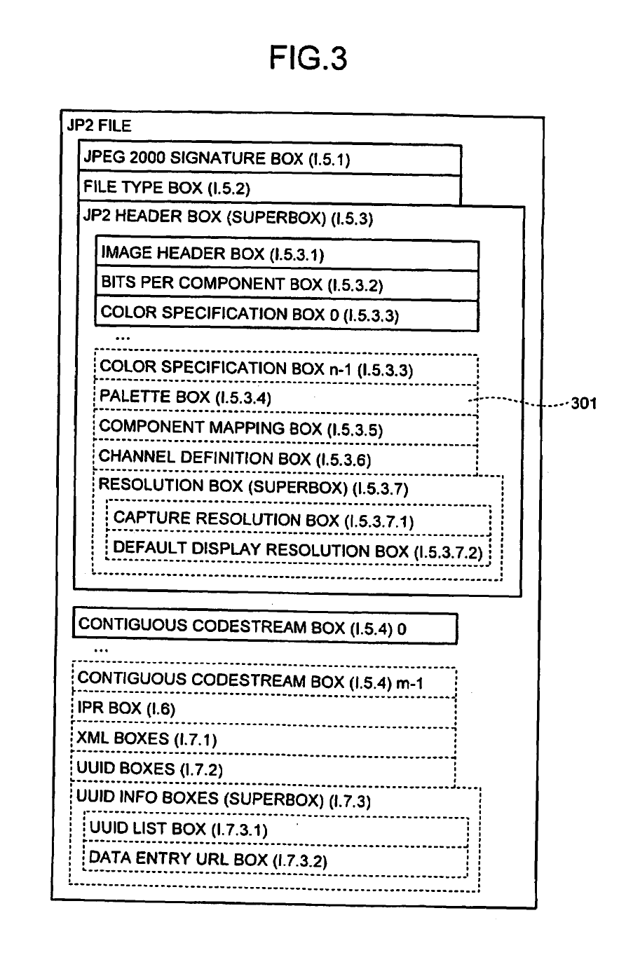

FIG. 3 is a schematic diagram of an example of the JP2 file format. As shown in FIG. 3, the JP2 file format includes a collection of units called “boxes”. Among the boxes, a pallet box 301 is used for generating channels from existing components. The pallet box 301 specifies a correspondence relation for converting a color index into an actual color (Red (R), Green (G), Blue (B) value, etc.).

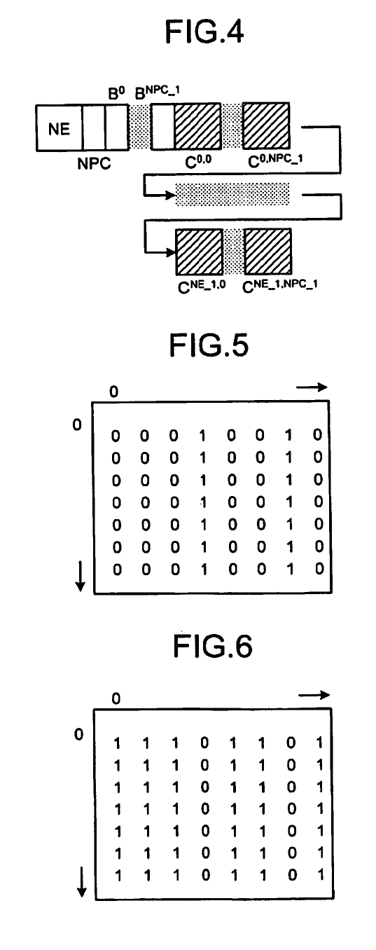

FIG. 4 is a schematic diagram for explaining a detailed structure of the pallet box 301. As shown in FIG. 4, the pallet box 301 includes a table entry (index) count (NE), a pallet color space count (NPC), a bit depth of a pallet group number i (Bi), and a value of a color space number j of the pallet group number i (Cji).

Returning to FIG. 2, first, the encoding unit 104 describes pallet data of the binary image data in the pallet box 301 (Step S205). For example, the encoding unit 104 sets two in the NE and one in the NPC because a binary index is converted into a monochromatic image. If zero is specified as the background pixel value, the encoding unit 104 sets zero as the pallet of the index 0 and sets one as the pallet of the index 1. However, if one is specified as the background pixel value, the pixel value is inverted before encoding and the pixel value 1 is replaced by the index 0. Thus, the encoding unit 104 sets zero as the pallet of the index 1 and sets one as the pallet of the index 0.

For example, if the binary index is to be converted into RGB full color, the encoding unit 104 sets NPC=3, and (R0, G0, B0)=(0, 0, 0) and (R1, G1, B1)=(255, 255, 255) as pallet-groups.

The encoding unit 104 executes JP2 encoding that is one of the file formats of the JPEG 2000 to the end to generate the JP2 file (Step S206).

Even if the code generated by the encoding process mentioned earlier is displayed on a viewer including a normal JPEG 2000 decoder in the same size as the size of the original image or in a reduced size, the code can be displayed as an exemplary image such that the exemplary image is of the same color as the color of the original image and breaking up of a thin line is reduced.

Principles by which an exemplary reduced image can be obtained by inverting the original image are simply explained below. In the lossless transform using the 5/3 filter, the one-dimensional lossless DWT is respectively applied in a horizontal direction and in a vertical direction. Normally, a lifting calculation in which calculation is omitted is used by considering downsampling after the DWT. The lifting calculation is indicated by Equations (1) and (2) mentioned below. Results obtained without using the lifting calculation are also the same.

$$\begin{matrix}Y ( 2 n + 1 ) = {X}_{ext} ( 2 n + 1 ) - [ \frac{{X}_{ext} ( 2 n ) + {X}_{ext} ( 2 n + 2 )}{2} ] & ( 1 ) \\ Y ( 2 n ) = {X}_{ext} ( 2 n ) + [ \frac{Y ( 2 n - 1 ) + Y ( 2 n + 1 ) + 2}{4} ] & ( 2 )\end{matrix}$$

In Equation (1), signals are obtained by downsampling a high-pass filter output in a proportion of 2:1. In Equation (2), signals are obtained by downsampling a low-pass filter output in a proportion of 2:1. Xₑₓₜ are signals obtained by extending one-dimensional input signals for smoothly referring to the pixels outside tile boundaries by suppressing discontinuity. In Equation (1), an output obtained after downsampling the high-pass filter output is calculated. In Equation (2), an output obtained after downsampling the low-pass filter output is calculated by using the output calculated in Equation (1).

FIG. 5 is a schematic diagram illustrating an example of image data having the pixel value of the thin line as one. FIG. 6 is a schematic diagram illustrating an example of image data having the pixel value of the thin line as zero.

As shown in FIG. 5, if the thin line is created by pixels of which pixel value is one, pixels of odd coordinate values are erased without remaining on low-pass components. However, the pixels of the thin line that exist on even coordinate values remain on the low-pass components. As shown in FIG. 6, if the thin line is created by the pixels of which pixel value is zero, similarly to the thin line of the odd coordinate values, the thin line of the even coordinate values is also erased from the low-pass components.

The thin line of the even coordinate values is erased from the low-pass components due to asymmetrical properties of Equation (1). For the sake of convenience, it is assumed that the thin line is positioned only on the even coordinate values. The high-pass components calculated in Equation (1) are prediction residuals of input signals. Thus, the high-pass components obviously become zero in a signal portion (portion in which the same pixel values are sequentially generated) in which the pixel values are not changed. Because the high-pass components on neighboring positions become one when the pixel value of the thin line is zero, the low-pass components become zero. However, because the high-pass components on the neighboring positions become zero when the pixel value of the thin line is one, the low-pass components become one. In other words, when the pixel value of the thin line is zero, data remains on the high-pass components without remaining on the low-pass components. However, when the pixel value of the thin line is one, data remains on the low-pass components without remaining on the high-pass components.

Thus, for displaying larger amount of thin line data when reduction decoding is performed, the pixel value 1, which causes larger amount of data to remain on the low-pass components, can be assigned to the thin line and the pixel value 0 can be assigned to the background pixel value.

In the explanation mentioned earlier, the encoding unit 104 generates the encoded data in the JP2 file format that can set pallet data. Apart from the JP2 file format, the encoded data can be generated in a JPC data format. In the JPC data format, the encoding unit 104 executes the encoding process only with respect to the image data in which the pixel values are inverted. In other words, in a first modification, the encoding unit 104 does not execute the process at Steps S205 and S206 according to the above embodiment. Thus, black and white values need to be inverted before displaying the image on the viewer.

In the explanation mentioned earlier, the specification of the background pixel value of the original image data is input by the input unit 101 and is used for determining whether the specified background pixel value is zero. In a second modification, the determining unit 102 determines from the original image data, the pixel value that need to be treated as the background pixel value. For example, the determining unit 102 measures, as the simplest method, the number of each pixel value in the original image data and assumes the pixel value of the large number as the background pixel value. The determining unit 102 sets a predetermined threshold (for example, ¾, etc.). Furthermore, the determining unit 102 can determine the background pixel value as one only when the total percentage of the number of pixels of which pixel value is one is greater than the threshold and invert an image. However, the method for determining the background pixel value is not to be thus limited. All the conventional methods, which can determine the pixel value that needs to be treated as the background, can be used.

In an example of a result of a decoding process explained below, binary image, which includes the thin line having the background pixel value as one, is treated as the original image and subjected to the lossless encoding using two methods. In the first method, the JPEG 2000 lossless encoding of the original image is performed without rearranging the original image and decoding is performed by reducing the resolution in two stages. In the second method, all the pixel values of the original image are inverted from zero to one and from one to zero. Subsequently, the JPEG 2000 lossless encoding is performed for the original image data and decoding is performed by reducing the resolution in two stages.

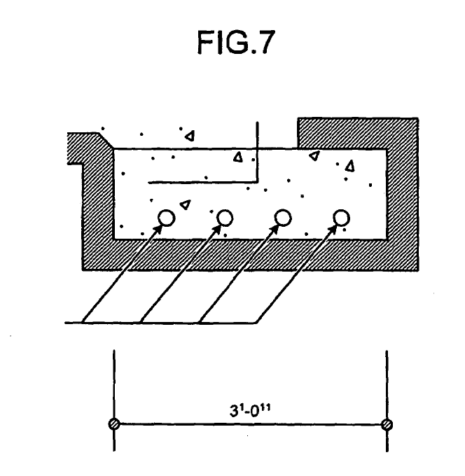

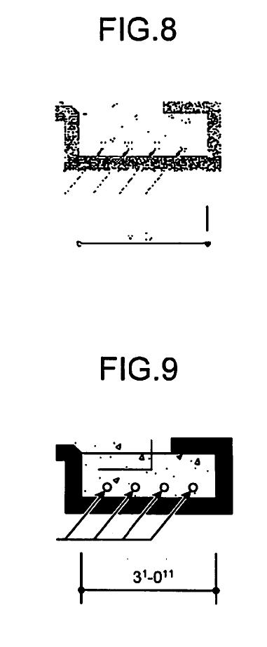

FIG. 7 is a schematic diagram illustrating an example of the original image data having the background pixel value as one. FIG. 8 is a schematic diagram illustrating an example of the processing result obtained by the first method. FIG. 9 is a schematic diagram illustrating an example of the processing result obtained by the second method. As shown in FIG. 9, if the pixel values are inverted and encoded by the method according the present embodiment, the unbroken thin line can be displayed even when the reduction decoding is performed. Because the binary image need not be extended to a multivalued image, a code size or a processing cost required for decoding does not increase.

Thus, in the image processing apparatus according to the present embodiment, when the image data is encoded by using the transform encoding system such as the JPEG 2000 system, the encoding process is executed after the pixel values of the original image data are inverted according to the background pixel value. Thus, in the encoding process in which the binary image is treated as the original image data, a code can be generated such that the thin line is unbroken even when a portion that needs to be displayed is reduction decoded and an encoding capacity is not substantially increased. Desirable results can be obtained when the original image and the reduced original image are displayed by using all decoding algorithms that do not execute any specific process and that conform to the JPEG 2000 standards.

A hardware configuration of the image processing apparatus according to the present embodiment is explained below.

The image processing apparatus according to the present embodiment includes a control device such as a central processing unit (CPU), a storage device such as a read only memory (ROM), and a random access memory (RAM), an external storage device such as a hard disk drive (HDD), and a compact disk (CD) drive, a display device, and an input device such as a keyboard and a mouse. Thus, the image processing apparatus uses the hardware configuration that is the same as the hardware configuration used in a typical computer.

An image processing program executed by the image processing apparatus according to the present embodiment is provided by storing the image processing program in a file of an installable or an executable format on a storage medium such as a CD-ROM, a flexible disk (FD), a compact disk recordable (CD-R), and a digital versatile disk (DVD) that are readable on the computer.

The image processing program executed by the image processing apparatus according to the present embodiment can be stored on the computer that is connected to a network such as the Internet. The stored image processing program can also be provided by downloading via the network. The image processing program executed by the image processing apparatus according to the present embodiment can be provided or distributed via the network such as the Internet.

The image processing program executed by the image processing apparatus according to the present embodiment can be prior embedded into the ROM and provided.

The image processing program executed by the image processing apparatus according to the present embodiment is a module structure including each unit such as the input unit, the determining unit, the replacing unit, the encoding unit, and the output unit. The CPU that is the actual hardware reads the image processing program from the storage medium and executes the image processing program. Due to this, each unit is loaded on a main storage device. Thus, each unit is generated in the main storage device.

According to an aspect of the present invention, an image code can be generated that ensures that a thin line is unbroken even when a portion that needs to be displayed is reduction decoded and that suppresses an increase in code size.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a determining unit that determines whether a background pixel value of image data matches a predetermined comparison value;
a replacing unit that replaces, when the determining unit determines that the background pixel value does not match the comparison value, a pixel value of a pixel of the image data with a replacing value that is obtained by subtracting the pixel value from a predetermined maximum pixel value; and
an encoding unit that generates encoded data by encoding the image data in which the pixel value is replaced with the replacing value by using a predetermined encoding system, wherein
the encoding system encodes the image data using transform coefficients obtained by transforming the image data into a plurality of frequency components and that includes a process of rounding the transform coefficients.

2. The image processing apparatus according to claim 1, wherein
the determining unit determines whether the background pixel value is zero, and
the replacing unit replaces the pixel value with the replacing value when the determining unit determines that the background pixel value is not zero.

3. The image processing apparatus according to claim 1, wherein the encoded data includes data representing a relation between an index that indicates pixel value data included in the encoded data and a pixel value in a color space of the image data.

4. The image processing apparatus according to claim 1, further comprising an input unit that inputs the background pixel value to the determining unit.

5. The image processing apparatus according to claim 1, wherein the determining unit obtains the background pixel value from the image data based on a predetermined rule.

6. The image processing apparatus according to claim 1, wherein
the image data is a binary image data, and
the maximum pixel value is either one of pixel values whichever is large in the binary image data.

7. The image processing apparatus according to claim 1, wherein the encoding system includes a discrete wavelet transform using a 5/3 filter.

8. The image processing apparatus according to claim 7, wherein the encoding system conforms to a joint photographic experts group 2000 that has a function of the discrete wavelet transform.

9. The image processing apparatus according to claim 1, wherein the encoding system includes a Hadamard transform.

10. An image processing method comprising:
determining whether a background pixel value of image data matches a predetermined comparison value;
replacing, when it is determined at the determining that the background pixel value does not match the comparison value, a pixel value of a pixel of the image data with a replacing value that is obtained by subtracting the pixel value from a predetermined maximum pixel value; and
generating encoded data by encoding the image data in which the pixel value is replaced with the replacing value by using a predetermined encoding system, wherein
the encoding system encodes the image data using transform coefficients obtained by transforming the image data into a plurality of frequency components and that includes a process of rounding the transform coefficients.

11. The image processing method according to claim 10, wherein
the determining includes determining whether the background pixel value is zero, and
the replacing includes replacing the pixel value with the replacing value when it is determined that the background pixel value is not zero at the determining.

12. The image processing method according to claim 10, wherein the encoded data includes data representing a relation between an index that indicates pixel value data included in the encoded data and a pixel value in a color space of the image data.

13. The image processing method according to claim 10, further comprising inputting the background pixel value to the determining.

14. The image processing method according to claim 10, wherein the determining includes obtaining the background pixel value from the image data based on a predetermined rule.

15. The image processing method according to claim 10, wherein
the image data is a binary image data, and
the maximum pixel value is either one of pixel values whichever is large in the binary image data.

16. The image processing method according to claim 10, wherein the encoding system includes a discrete wavelet transform using a 5/3 filter.

17. The image processing method according to claim 16, wherein the encoding system conforms to a joint photographic experts group 2000 that has a function of the discrete wavelet transform.

18. The image processing method according to claim 10, wherein the encoding system includes a Hadamard transform.

19. A computer program product comprising a computer-usable medium having computer-readable program codes embodied in the medium that when executed cause a computer to execute:
determining whether a background pixel value of image data matches a predetermined comparison value;
replacing, when it is determined at the determining that the background pixel value does not match the comparison value, a pixel value of a pixel of the image data with a replacing value that is obtained by subtracting the pixel value from a predetermined maximum pixel value; and
generating encoded data by encoding the image data in which the pixel value is replaced with the replacing value by using a predetermined encoding system, wherein
the encoding system encodes the image data using transform coefficients obtained by transforming the image data into a plurality of frequency components and that includes a process of rounding the transform coefficients.
